(19) United States
(12) Patent Application Publication
(10) Pub. No.: US 2024/0286510 A1
(43) Pub. Date: Aug. 29, 2024

(54) SYSTEM FOR ENERGY STORAGE AND DISTRIBUTION

(71) Applicant: MGES, LLC, Kansas City, KS (US)

(72) Inventors: Mitchell C. Waldberg, Leawood, KS (US); Craig Fritts, Kearney, MO (US)

(73) Assignee: MGES, LLC, Kansas City, KS (US)

(21) Appl. No.: 18/590,463

(22) Filed: Feb. 28, 2024

Related U.S. Application Data
(60) Provisional application No. 63/502,530, filed on May 16, 2023.
(60) Provisional application No. 63/487,367, filed on Feb. 28, 2023.

(51) Int. Cl. B60L 53/53; B60L 53/62; H02J 7/00

(52) U.S. Cl. CPC B60L 53/53; B60L 53/62; H02J 7/0071; B60L 2210/40

(57) ABSTRACT

An energy storage and distribution system includes one or more battery energy storage systems (BESS) for storing electrical energy in batteries, and a power distribution module (PCM) for distributing power from the batteries to AC and/or DC electric vehicle chargers for charging electric vehicles (EVs). Incoming AC power is provided to each BESS, which may be connected or disconnected from the incoming AC power. In one embodiment, two BESS systems may be independently isolated from the incoming AC power such that the batteries in one BESS system may be charging while the other BESS is providing output power from its batteries. In another embodiment, connection to the incoming AC power is scheduled to allow the batteries to be charged during off-peak times. In another embodiment, connection to the incoming AC power is combined with the BESS stored electrical power to provide a higher available capacity that either operating alone.

### CROSS-REFERENCE TO RELATED APPLICATIONS

This application claims the benefit of U.S. Provisional Patent Application No. 63/487,367, filed Feb. 28, 2023, and of U.S. Provisional Patent Application No. 63/502,530, filed May 16, 2023, the disclosure of each of which is hereby incorporated herein in its entirety by reference.

### BACKGROUND

### Field

The present invention relates generally to the field of electrical energy transmission, and more particularly to a system for storing and distributing electrical energy for use in powering electrical vehicle chargers and other devices and systems.

### Description of the Related Art

Electric vehicles (EVs) are becoming more popular and commonly available throughout the world, with users able to choose from various makes and models of cars, trucks, and sport-utility vehicles (SUVs) to suit their needs. In response to the increasing popularity of EVs, vehicle manufacturers and dealers, as well as state and local governments, have invested and facilitated the installation of energy transmission infrastructure and EV charging stations to allow users of EVs to charge their vehicles at an increasing number of locations.

Because of the need to maintain and service multiple EVs daily, automobile dealers in particular rely on having one or more EV charging stations to allow them to keep multiple EVs charged and ready for customers to test drive, as well as to charge multiple EVs being serviced or repaired each day. Since each EV charging station requires a relatively high current draw from the power grid, operating multiple charging stations simultaneously presents challenges to the existing power systems of most dealer facilities.

For example, a conventional automobile dealership's building and service facilities consume electricity for lighting, HVAC and equipment operation, while a dealership equipped with multiple EV charging stations must typically have an upgraded, high-power electrical system in order to accommodate the significantly higher current and power required by the charging stations. Such upgrades to the building electrical systems are costly and time consuming, with the lead-time required to obtain the necessary upgraded high-current components often being several months or more.

Furthermore, once installed, high-power charging stations place a significant load on the local power grid or other incoming power system such that the external facility providing the power (e.g., a power substation serving one or more dealerships) may likewise need to be upgraded. Thus, there is often significant difficulty, cost, and time delay in upgrading a dealership facility and infrastructure to accommodate multiple EV charging stations.

Once upgraded, because dealerships and their service departments typically operate during normal business hours, the large amount of electricity required to operate multiple charging stations during those hours is often billed at peak rates—i.e., because the dealership demand occurs during peak electricity usage times, the dealerships must pay a premium price for the electricity necessary to operate the charging stations in addition to the electricity required for normal operation of the facility. Thus, beyond just the cost of upgrading their electrical power system to accommodate multiple EV charging stations, once installed the dealers must also pay a premium price for the electricity provided by the upgraded system.

The delay and cost involved in upgrading places additional competitive pressure on the dealerships, leading some dealers or service facilities to opt-out of upgrading their systems to accommodate electric vehicles. However, many dealers face mandates by their associated manufacturers to make such upgrades on an accelerated time schedule in order to maintain their franchise or dealership.

Thus, it can be seen that there remains a need in the art for a system that provides the capability to operate multiple EV charging stations while avoiding the drawbacks of conventional high-current upgraded system upgrades.

### SUMMARY OF THE DISCLOSURE

An energy storage and distribution system in accordance with an exemplary embodiment of the present invention includes one or more battery energy storage systems (BESS) for storing electrical energy in batteries, and a power distribution module PCM for distributing power from the batteries to AC and/or DC electric vehicle chargers for charging electric vehicles (EVs). Incoming AC power is provided to each BESS, with logic and control circuitry in each BESS operable to connect or disconnect from the incoming AC power. In one embodiment, two BESS systems may be independently isolated from the incoming AC power such that the batteries in one BESS system may be charging while the other BESS is providing output power from its batteries. In another embodiment, connection to the incoming AC power is scheduled to allow the batteries to be charged during off-peak times.

In one aspect, the system for energy storage and distribution comprises first and second battery energy storage systems (BESS) configured to receive AC power from one or more power inputs. Incoming AC power is directed through a breaker panel and to the first and second BESS system, which each include a plurality of batteries for storing energy and a bidirectional inverter which is operable to charge the batteries from the incoming AC power and to convert energy stored in the batteries to AC power. Logic and control circuitry in each BESS controls a contactor or breaker in the BESS, allowing each BESS to be independently isolated from the incoming AC power.

AC power generated from the batteries by the inverter is directed to an electrical distribution module (PCM) The PCM provides various power outputs such as AC electric vehicle chargers (or AC charging piles), DC electric vehicle chargers (or DC charging piles), and building AC power wherein the system provides power to the building power grid/system in which it is located.

In one aspect, the system for energy storage and distribution is well-suited for use in an automobile dealership or service building to allow charging of multiple electric vehicles simultaneously from the energy stored in the batteries of the BESS systems, and to effectively increase the AC power capacity available to the dealership facility without having to upgrade the existing AC power system.

### BRIEF DESCRIPTION OF THE DRAWINGS

Illustrative embodiments of the invention are described in detail below with reference to the attached drawing figures, and wherein:

FIG. 1 is a block diagram schematic of a system for energy storage and distribution system in accordance with an exemplary embodiment of the present invention.

FIG. 2 is an expanded block diagram schematic view of the battery energy storage system (BESS) component of FIG. 1.

FIG. 3 is a perspective view of two cabinets housing two separate battery energy storage systems (BESS) of FIG. 1.

FIG. 4 is a perspective view of two cabinets housing a power distribution module (PCM) of FIG. 1.

FIG. 5 is a flow diagram of an exemplary operation of the energy storage and distribution system in accordance with an exemplary embodiment of the present invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

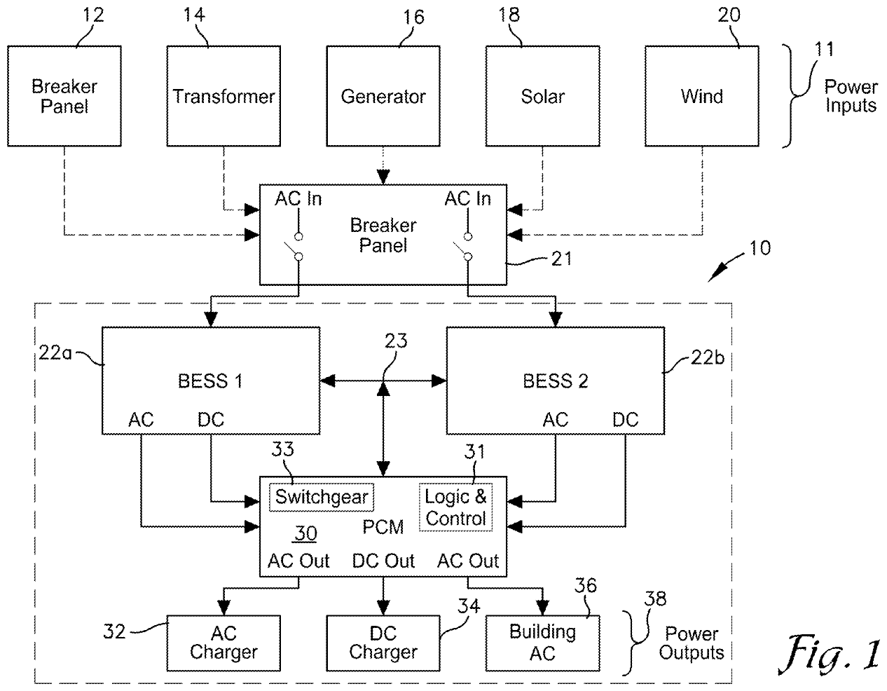

Looking to FIG. 1, a system for energy storage and distribution in accordance with an exemplary embodiment of the present invention is depicted as element number 10.

The system for energy storage and distribution 10 generally comprises first and second battery energy storage systems (BESS) 22a, 22b configured to receive AC power from one or more power inputs 11. Incoming AC power is directed through a breaker panel 21 and to the first and second BESS systems 22a, 22b. First and second BESS systems 22a, 22b (as will be described in more detail below) each include a plurality of batteries for storing energy and a bidirectional inverter which is operable to charge the batteries from the incoming AC power and to convert energy stored in the batteries to AC power. Logic and control circuitry in each BESS 22a, 22b controls a contactor or breaker in the BESS, allowing each BESS to independently isolate from the incoming AC power.

DC power stored in the batteries by the inverter is sent to the power control module (PCM) 30 where it is either directed to the invertes to be converted to AC power, or sent directly to the DC Out breaker iPCM 30. The PCM provides various power outputs 38 such as AC electric vehicle chargers (or AC charging piles), DC electric vehicle chargers (or DC charging piles), and building AC power.

With the overall configuration of the system for energy storage and distribution 10 set forth, a detailed description of the system and its operation is now provided with reference to FIGS. 1 through 5.

Looking to FIG. 1, incoming AC power to the system for energy storage and distribution 10 may be from any combination of power inputs 11, such as a breaker panel 12, a building transformer 14, a generator 16, and solar 18 or wind 20 inputs. While AC input to a dealership or service facility would typically be from a building breaker panel 12, such as a breaker box, in some instances the system 10 may be wired directly to provide power back to the building breaker panel 21 for use by the building in the case of an emergency or to limit peak power usage by the building during peak electrical rate hours. AC from a generator, solar, or wind sources may be used to directly power the system 10, or may be connected to the incoming AC power grid input to supplement that power as is known in the art.

Incoming AC power is preferably directed to a breaker panel 21 or junction box dedicated to the system for energy storage and distribution to allow the system 10 to be independently disconnected from the AC power input for installation, maintenance or repair. From the breaker panel 21, incoming AC power is directed to first and second BESS systems 22a, 22b.

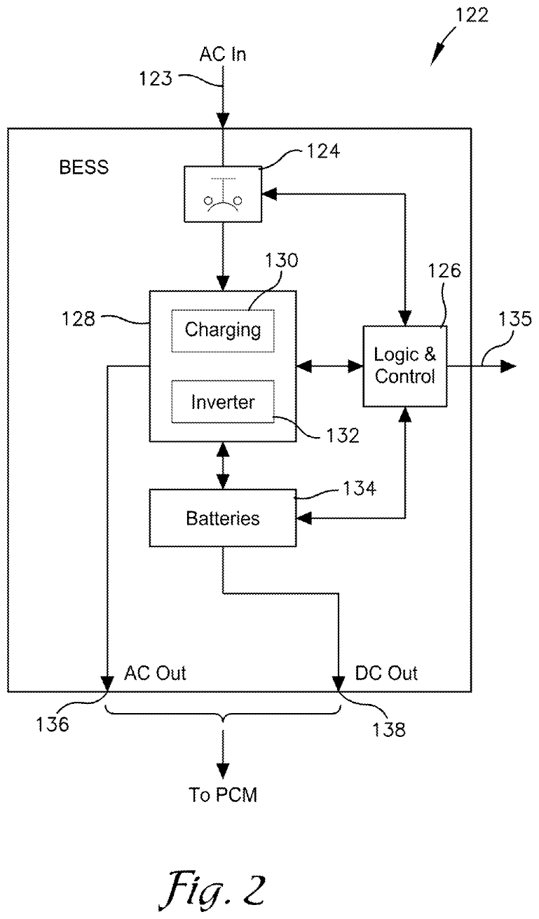

Turning to FIG. 2, a detailed view of a BESS system (such as BESS systems 22a, 22b of FIG. 1) is depicted as element number 122. The BESS system includes a breaker 124 operable to connect or disconnect incoming AC power to/from the BESS 122 so that the BESS can be connected to, or isolated from, the incoming AC power. Breaker 124 is preferably an electrically actuated breaker or contactor actuated by logic and control circuitry 126 in the BESS.

Logic and control circuitry 126 preferably comprises one or more processors, data storage, and memory having instructions stored thereon which, when executed by the processors, cause the logic and control circuitry to perform various actions to control the operation of the BESS 122, such as actuating breaker 124 to connect or disconnect the BESS from the incoming AC power. Logic and control circuitry 126 preferably further includes time, date, and clock/timing functionality to allow the circuitry to perform scheduled tasks or routines, and included signal conditioning circuitry, sensors, and input/output circuitry to allow the logic and control circuitry to monitor various BESS system parameters, such as voltages, currents, and temperatures, and to monitor and control other components or devices within the BESS.

Looking still to FIG. 2, incoming AC power 123 to the BESS 122 is connected to bidirectional inverter 128 which is operable to charge the plurality of batteries 134 in the BESS as well as to convert the DC power from the batteries 134 to AC power for distribution from the BESS. Bidirectional inverter 128 includes charging circuitry 130 and DC to AC inverter circuitry 132 to perform those functions. In alternative embodiments, BESS 122 may include separate charging circuitry 130 and inverter circuitry 132 rather than a bidirectional inverter to accomplish the same functionality.

Batteries 134 preferably comprises a bank of six separate batteries connected in series. The batteries may be lithium iron phosphate batteries, lithium-ion batteries, or other high capacity storage batteries. In alternative embodiments the number of batteries may be more or fewer than six to allow scaling the capacity of the BESS for particular applications. In still further embodiments, the lithium-ion batteries may be connected in combined parallel and series configurations to achieve a desired voltage and/or capacity for a particular application.

Logic and control circuitry 126 is in communication with breaker 124, with the inverter 128, and with batteries 134, and is further configured to communicate via a communications connection 135 to other BESS system and to an PCM such as PCM 30 as described with respect to FIG. 1. In alternative embodiments the logic and control circuitry may further communicate with other components or devices in the BESS, with other external equipment having communication capability, and with external computers or controller used to monitor and/or control the BESS 122. Users may communicate with the logic and control circuitry to view and/or modify system parameters, and to check and update schedules and other operating rules for the system 10.

As depicted and described, the BESS 122 thus may provide AC power output 136 and DC output 138 for connection to an PCM (as described in the system of FIG. 1). It should be understood that the BESS 122 is configured to operate in two distinct modes: a first mode in which breaker 124 is closed such that incoming AC power is applied to the bidirectional inverter 128 which in turn charges the batteries 134, and a second mode in which breaker 124 is open such that there is no incoming AC power and the batteries discharge through the bidirectional inverter 128 which provides AC output power 136 to an PCM. In further embodiments, in a third mode AC breaker 124 is closed while the batteries discharge through the bidirectional inverter 128. This allows the allowable power available through the input AC breaker 124 to be combined with the BESS available power to effectively provide a higher available power capability of the BESS module.

It should also be understood that while in the second mode (i.e., the discharge mode) that the BESS may provide both AC output power 136 and DC output power 138 to allow the PCM to distribute AC and DC power to various equipment, such as AC electric vehicle chargers and DC electric vehicle chargers. In alternative embodiments the BESS may be configure to provide only an AC output.

Turning back to FIG. 1, each BESS system 22a and 22b is configured as described above with respect to FIG. 2. As seen in FIG. 1, and as described with respect to FIG. 2, the AC output and DC output of each BESS system 22a, 22b is distributed to PCM 30.

PCM 30 comprises logic and control circuitry 31 and switchgear 33. Logic and control circuitry 31 within the PCM is operable to monitor and control components and devices within the PCM and to communicate with the BESS systems 22a, 22b and other external equipment and devices. Similar to the logic and control circuitry within the BESS as described with respect to FIG. 2, the logic and control circuitry 31 in the PCM preferably comprises one or more processors, data storage, and memory having instructions stored thereon which, when executed by the processors, cause the logic and control circuitry to perform various actions to control the operation of the PCM 30 and may further include time, date, and clock/timing functionality to allow the circuitry to perform scheduled tasks or routines, and included signal conditioning circuitry, sensors, and input/output circuitry to allow the logic and control circuitry 31 to monitor various PCM system parameters, such as voltages, currents, and temperatures, and to monitor and control other components or devices within the PCM.

Switchgear 33 within the PCM 30 is operable to route and distribute the AC and DC power from the two BESS systems 22a, 22b. The switchgear 33 preferably comprises distribution hardware including switches, fuses, isolators, relays, circuit breakers, contactors, bus bars, cables, wiring, and the like.

As depicted in FIG. 1, the PCM provides various power outputs to various devices 38 with AC outputs for powering AC electric vehicle chargers 32 (or AC charging piles) or a building AC system 36, and DC outputs for powering DC electric vehicle chargers (or DC charging piles). It should be understood that in some embodiments the AC output of the PCM may be used to provide AC power to the building or facility where it is installed (i.e., the building AC system 36 in FIG. 1) to allow operation of the building's normal AC power system via the BESS systems and the PCM. In preferred embodiments, the AC outputs and DC outputs of the PCM 30 comprise industry standard connectors to allow standard electric vehicle chargers to connect to the PCM.

It should be understood that the capacity of the charged batteries in each BESS system preferably exceeds the nominal capacity of the incoming AC used to charge the batteries, thus the system of the present invention provides greater power than is nominally available from the incoming building AC.

For example, the incoming AC power to a dealership building may be 100 kilowatts, which is insufficient to operate the building and multiple EV chargers simultaneously. However, by using the incoming AC power to power the building while simultaneously charging the batteries of the BESS system allows the dealership to, once charged, use the power stored in the batteries of the BESS to simultaneously operate several EV chargers, for example up to 250 kilowatts or more depending on the number of batteries in the BESS and the number of BESS and PCM modules installed an connected onsite.

Thus, by converting incoming AC to energy stored in the batteries of the BESS, the system of the present invention effectively increases the operational capacity of the dealership, allowing them to effectively operate at a 250 kilowatt level without having to upgrade their existing 100 kilowatt building electrical system or having to install new high-capacity building switchgear which typically has a very long lead time—e.g., over one year—for delivery and installation. In a typical installation the system configuration will comprise two BESS and two PCM modules for a total BESS capacity of 500 kW. When combined with the incoming 100 KW to each of the two BESS units, the total system will have an overall capacity of 700 KW (250+250 KW for two BESS units and 100+100 KW incoming power, for a total of 700 kW).

Furthermore, with the system of the present invention having two BESS systems as described above, with each BESS system able to be independently isolated from the incoming AC power, a dealership may use a first, charged BESS (isolated from the incoming AC) while the building AC is used to operate the building and simultaneously charge a second BESS. If the first BESS becomes depleted, the system may switch to the second BESS system to allow the EV chargers to continue to operate from the second BESS while the first BESS is being recharged. Thus, the system of the present invention effectively increases the electrical capacity of the dealership without necessitating upgrading the building's AC power system.

Furthermore, as described herein, the system of the present invention further allows scheduling the charging of the BESS systems so that a dealership may charge the BESS systems overnight or at off-peak hours to avoid having to incur peak usage charges which may be imposed if charging during the day. With two BESS systems the system of the present invention can thus switch between the two to provide a desired usage and charging schedule.

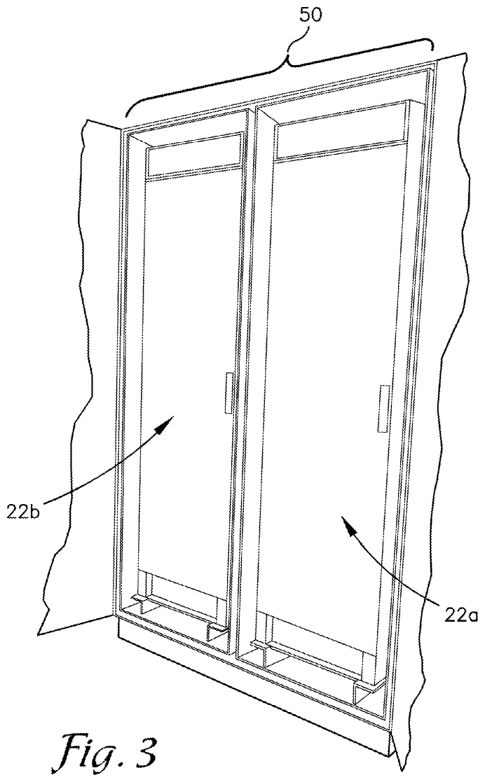

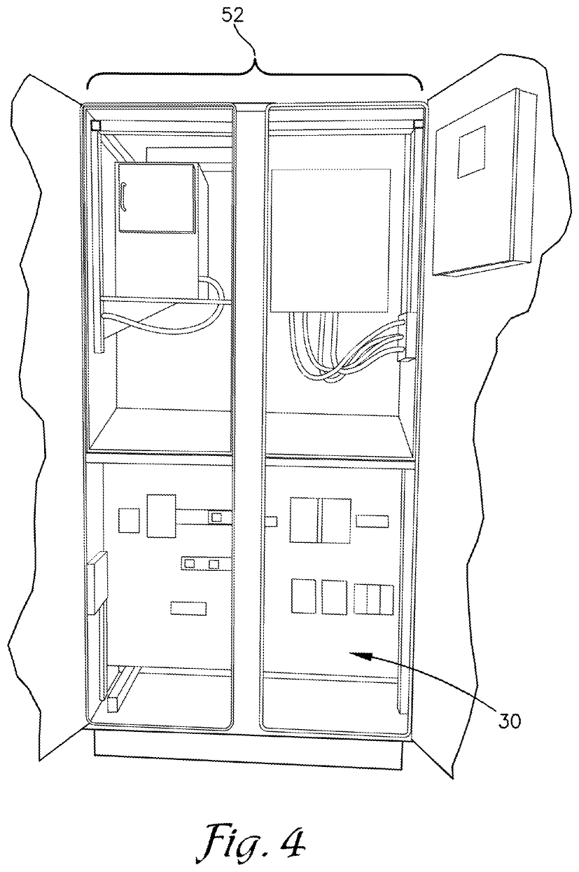

Turning to FIGS. 3 and 4, the BESS systems 22a, 22b are preferably installed in cabinets for installation outside a building or dealership service area. As seen in FIG. 3, two cabinets 50 contain the first and second BESS systems 22a, 22b with the batteries and logic and control circuitry installed behind the cabinet panels. As seen in FIG. 4, the PCM is likewise installed in two cabinets 52, with plugs or ports accessible for connecting electric vehicle chargers. It should be understood that the arrangement of the BESS systems and PCM within the cabinets may vary from that depicted, and that in preferred embodiments the BESS systems may be separately housed from the PCM. It should be further understood that various arrangements of BESS systems and PCMs are within the scope of the present invention, for example, each BESS may be paired with a separate PCM and installed in separate locations within a building or facility. With the hardware configuration of the system for energy storage and distribution set forth, the operation of the system will now be described.

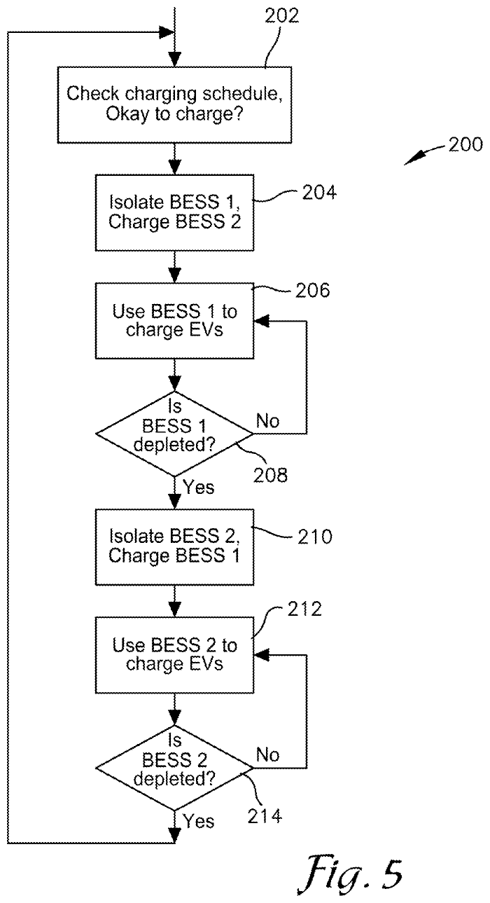

Turning to FIG. 5, and with reference to FIG. 1, a flow diagram of an exemplary operation of the system of the present invention is depicted as numeral 200.

At block 202 logic and control circuitry in the first and second BESS units 22a, 22b, check the charging schedule to determine if charging should proceed at that time. The charging schedule preferably may take into account peak and off-peak electricity rates, anticipated demand for charging, the current status of the batteries and other system components in each of the input the BESS systems, and any user commands or rules to apply in determining whether to charge either, both, or neither of the BESS systems.

At block 204, if charging is to proceed the logic and control circuitry isolates the first BESS system, i.e., by opening the breaker 124 to disconnect the incoming AC power to the BESS, and proceeds to charge the batteries in the second BESS system by connecting incoming power through the breaker so that the batteries charge via the bidirectional inverter in the manner as described above.

At block 206, while the second BESS is charging, the first BESS may be used to charge electric vehicles by connecting an AC or DC charger to the appropriate output of the PCM.

At block 208, the status of the first BESS, which is being used and/or is available to charge EVs, is checked to see if the batteries are depleted or otherwise need to be charged, for example based on a user-entered parameter to recommend charging when the batteries reach a predetermined level, etc.

If, at block 208, the batteries of the first BESS are not depleted, then the logic and control circuitry will continue to periodically check the status. If, at block 208, the batteries are depleted or otherwise need to be charged, then at block 210 the logic and control circuitry in the second BESS opens its breaker to isolate it from the AC input, and the logic and control circuitry in the first BESS closed its breaker to allow the AC input to charge the batteries. Thus, at block 210, the roles of the first and second BESS systems have been flipped, with the first BESS now charging while at the second BESS is isolated from the incoming AC. At block 212, the second BESS is used and/or available to charge EVs.

Finally, at block 214 the charging status of the second BESS is checked to see if it has been depleted or otherwise needs charging. If not, then the logic and control periodically checks the status. If so, then the entire process is repeated such that the first and second BESS systems are alternatively isolated and/or charged as required.

It should be understood that the method of charging as just described is exemplary, and that other sequences of charging and selectively isolating the first and second BESS systems may be used in accordance with the present invention. For example, in some installations there may be no difference in peak and off-peak electricity usage so that time scheduling for such usage may not be necessary. Or in some installations it may be possible or necessary to charge the first and second BESS systems simultaneously. In other installations it may be necessary to combine the capacity of the BESS modules with the capacity from the incoming power grid through the AC input breaker 124 to obtain higher EV charging capacities. These and other sequences and implementation rules may be easily accommodated by the system of the present invention by programming or directing the logic and control circuitry of each BESS and PCM to accomplish the desired charging scheduling.

Thus, the system for energy storage and distribution 10 is well-suited for use in an automobile dealership or service building to allow charging of multiple electric vehicles simultaneously from the energy stored in the batteries of the BESS systems, and to effectively increase the AC power capacity available to the dealership facility without having to upgrade the existing AC power system.

It should be understood that the embodiments described herein are exemplary and that the system for energy storage and distribution as described herein may be configured in various manners and may be used in various fields beyond EV charging. For example, the BESS and PCM modules may be used in the fields of fleet or rental cars, multi-family parking areas, parking lots and garages, or any other applications where the utility grid cannot provide a high amount of power. Thus, for example, in the case of a multi-family housing units with multiple vehicles charging when not in operation, the system as described herein may be scaled to power 50 to 100 EV chargers (or more). With each BESS powering 25 or more of those EV chargers (at 20 KW each), the system as described herein can provide a 500 kW charging system from standard grid power of 100 KW. And, in the case of electrical load to a building where high demand spikes may occur, with a 24 hour charging rate at 50 KW the system as describe herein may store 1200 kWh (50 kW*24 hours), while traditional energy storage systems cannot simultaneously charge and discharge.

What is claimed is:

1. An energy storage and distribution system, comprising:
first and second battery energy storage systems (BESS), each comprising: a plurality of batteries operable to store energy; charging circuitry operable to charge the plurality of batteries from incoming AC power; inverter circuitry operable to convert DC power from the plurality of batteries to AC power; breaker circuitry operable to connect and disconnect the incoming AC power; and logic and control circuitry operable to monitor system parameters, communicate with logic and control circuitry of other system components, and to actuate the breaker circuitry to connect and disconnect the incoming AC power;
a power distribution module (PCM) in electrical communication with the first and second BESS systems, the PCM comprising: switchgear and distribution hardware operable to connect, disconnect, route, and distribute alternating current (AC) and direct current (DC) power from the first and second BESS systems to power output connections; and logic and control circuitry operable to control the switchgear to provide a desired distribution of power;
wherein the logic and control circuitry of each of the first and second BESS systems communicate such that each of the first and second BESS systems may be independently isolated from incoming AC power by actuating the corresponding breaker circuitry.

2. The energy storage and distribution system of claim 1, wherein the logic and control circuitry of each of the first and second BESS systems is operable to connect incoming AC power to a single one of the first and second BESS systems to allow charging of the batteries in that one BESS system and to simultaneously disconnect incoming AC power to the other one of the first and second BESS systems such that only one of the first and second BESS systems is charging at a time.

3. The energy storage and distribution system of claim 1, wherein the logic and control circuitry of each of the first and second BESS systems is operable to schedule connection of incoming AC power such that charging of the batteries occurs only in off-peak times.

4. The energy storage and distribution system of claim 1, wherein the power output connections comprise: outputs to AC electric vehicle chargers, outputs to DC electric vehicle chargers, outputs to building AC power, or combinations thereof.

5. The energy storage and distribution system of claim 1, wherein the charging circuitry and inverter circuitry comprise a bidirectional inverter.

6. The energy storage and distribution system of claim 1, wherein the system parameters monitored by the logic and control circuitry comprise system voltages, system currents, system temperatures, times, dates, or combinations thereof.

7. The energy storage and distribution system of claim 1, wherein the switchgear and distribution hardware comprises switches, fuses, isolators, relays, circuit breakers, contactors, bus bars, cables, wiring, or combinations thereof.

8. An energy storage and distribution system, comprising:
a battery energy storage system (BESS) comprising: a plurality of batteries operable to store energy; charging circuitry operable to charge the plurality of batteries from incoming AC power; inverter circuitry operable to convert DC power from the plurality of batteries to AC power; breaker circuitry operable to connect and disconnect the incoming AC power; and logic and control circuitry operable to monitor system parameters, communicate with logic and control circuitry of other system components, and to actuate the breaker circuitry to connect and disconnect the incoming AC power;
a power distribution module (PCM) in electrical communication with the BESS system, the PCM comprising: switchgear and distribution hardware operable to connect, disconnect, route, and distribute alternating current (AC) and direct current (DC) power from the BESS system to power output connections; and logic and control circuitry operable to control the switchgear to provide a desired distribution of power;
wherein the logic and control circuitry of each of BESS system is operable to connect or disconnect the incoming AC power by actuating the breaker circuitry.

9. The energy storage and distribution system of claim 8, wherein the logic and control circuitry is operable to schedule connection of incoming AC power such that charging of the batteries occurs only in off-peak times.

10. The energy storage and distribution system of claim 8, wherein the power output connections comprise: outputs to AC electric vehicle chargers, outputs to DC electric vehicle chargers, outputs to building AC power, or combinations thereof.

11. The energy storage and distribution system of claim 8, wherein the charging circuitry and inverter circuitry comprise a bidirectional inverter.

12. The energy storage and distribution system of claim 8, wherein the system parameters monitored by the logic and control circuitry comprise system voltages, system currents, system temperatures, times, dates, or combinations thereof.

13. The energy storage and distribution system of claim 8, wherein the switchgear and distribution hardware comprises switches, fuses, isolators, relays, circuit breakers, contactors, contactors, bus bars, cables, wiring, or combinations thereof.

14. An energy storage and distribution system, comprising: first and second battery energy storage systems (BESS), each comprising: a plurality of batteries operable to store energy; a bidirectional inverter operable to charge the plurality of batteries and to convert DC power from the plurality of batteries to AC power; and logic and control circuitry operable to actuate breaker circuitry to connect and disconnect the incoming AC power such that each of the first and second BESS systems may be independently isolated from incoming AC power.

15. The energy storage and distribution system of claim 14, wherein the logic and control circuitry of each of the first and second BESS systems is operable to schedule connection of incoming AC power such that charging of the batteries occurs only in off-peak times.

16. The energy storage and distribution system of claim 14, wherein each BESS provides power outputs to AC electric vehicle chargers, power outputs to DC electric vehicle chargers, power outputs to building AC power, or combinations thereof.

17. The energy storage and distribution system of claim 14, wherein the logic and control circuitry is operable to monitor system voltages, system currents, system temperatures, times, dates, or combinations thereof.

18. The energy storage and distribution system of claim 14, further comprising switchgear and distribution hardware for routing power from each BESS, wherein the switchgear and distribution hardware comprises switches, fuses, isolators, relays, circuit breakers, contactors, bus bars, cables, wiring, or combinations thereof.
